(19) United States
(12) Patent Application Publication
(10) Pub. No.: US 2022/0101148 A1
(43) Pub. Date: Mar. 31, 2022

(54) MACHINE LEARNING ENHANCED TREE FOR AUTOMATED SOLUTION DETERMINATION

(71) Applicant: International Business Machines Corporation, Armonk, NY (US)

(72) Inventors: June-Ray Lin, Taipei City (TW); Qin Qiong Zhang, Beijing (CN); Wu Song Fang, Beijing (CN); Jie Yang, Beijing (CN); Yu Li, Beijing (CN); Li Juan Long, Beijing (CN)

(21) Appl. No.: 17/031,898

(22) Filed: Sep. 25, 2020

(51) Int. Cl. G06N 5/00; G06N 20/20; G06N 5/04

(52) U.S. Cl. CPC G06N 5/003; G06N 5/04; G06N 20/20

(57) ABSTRACT

Some embodiments of the present invention are directed towards techniques for building and using machine learning enhanced trees for automated solution determination in a technical support context. Historical technical support records with associated problems, actions and results are received and clustered. A solution determination tree is constructed from the clustered actions, and a machine learning model is trained to predict which action will lead to a solution based on an accumulated data set including a problem and subsequent results from previous actions. Using the solution determination tree and the machine learning model, classes of actions are recommended based on accumulated data for an incoming support request/problem or a result resulting from a executing a previously recommended action.

### BACKGROUND

The present invention relates generally to the field of technical support tools, and more particularly to machine learning enhanced automated solution analysis and identification.

Technical support (frequently abbreviated to tech support) describes services that entities provide to users of technology products or services. Typically, technical support provide assistance regarding specific problems with a product or service, rather than providing training, provision or customization of product, or other support services. Most companies provide technical support for the products and services that they sell. Technical support may be provided by phone, e-mail, and/or live support software on a website or other tool where users can report an incident.

Technical support is frequently subdivided into tiers, or levels, in order to better serve a business or customer base. A typical support structure is delineated into a three-tiered technical support system. Tier I (or Level 1, shortened as T1 or L1) is the initial level of support responsible for basic customer issues. It is synonymous with first-line support, level 1 support, front-end support, support line 1, and various other descriptions for basic level technical support functions. The first job of a Tier I specialist is to gather information from the customer and to identify the customer's issue by analyzing the symptoms and determining the underlying problem. Typical information provided by the customer/end user could be a computer system name, screen name or report name, error or warning message displayed on the screen, any logs files, screen shots, any data used by the end user or any sequence of steps used by the end user, etc.

Tier II (or Level 2, abbreviated as T2 or L2) typically is a more in-depth technical support level than Tier I. It is synonymous with level 2 support, support line 2, administrative level support, and various other terms describing advanced technical troubleshooting and analysis methods. Technicians in this tier are responsible for assisting Tier I specialists in solving basic technical problems and for investigating elevated issues by confirming the validity of the reported problem and searching for known solutions related to these more complex issues. The L2 team is required to collect information as well, and typical types of information collected may include the program name that has failed or application name or any database related details (package name, table name, view name, etc.) or API (Application Programmable Interface) names. If a problem is new and/or personnel from this group cannot determine a solution, they are responsible for escalating this issue to the Tier III technical support group.

Tier III (or Level 3, abbreviated as T3 or L3) is the highest tier of support in a three-tiered technical support model and is tasked with handling the most difficult or advanced problems. It is synonymous with level 3 support, 3rd line support, back-end support, support line 3, high-end support, and various other descriptions for expert level troubleshooting and analysis methods. These individuals are typically experts and are responsible for not only providing assistance to both Tier I and Tier II specialists, but also with the research and development of solutions to new or unknown issues. Often developers or persons who know the code or backend of the product are included in the Tier 3 support team.

In computer science, a tree is a commonly used abstract data type (ADT) that represents a hierarchical tree structure, with a root value and subtrees of children with a parent node, represented as a set of linked nodes. A tree data structure may be constructed recursively as a collection of nodes (starting at a root node), where each node is a data structure including a value, together with a list of references to nodes (the “children”), with constraints stipulating that no duplicate references exist and the root node is not the child of any other node.

Machine learning (ML) is the study of computer algorithms which automatically improve through experience. It is typically viewed as a subset of artificial intelligence (AI). Machine learning algorithms typically construct a mathematical model based on sample data, sometimes known as “training data”, in order to determine predictions or decisions without being specifically programmed to do so.

Semantic similarity is a metric applied to a set of terms or documents, where a distance between items is based on the likeness of their semantic content or meaning instead of lexicographical similarity. These are mathematical tools used to approximate the strength of the semantic relationship between units of language, concepts or instances, through a numerical description obtained by comparison of information supporting their meaning or describing their nature. At a high level of generality, semantic similarity, semantic distance, and semantic relatedness typically mean, “How much does term X have to do with term Y?” The answer to this question is often expressed as a numerical value ranging between −1 and 1, or between 0 and 1, where 1 represents a significant degree of similarity.

### SUMMARY

According to an aspect of the present invention, there is a method, computer program product and/or system that performs the following operations (not necessarily in the following order): (i) receiving a historical technical support records data set including a plurality of technical support records, where a technical support record includes at least one problem description, at least one support action description and at least one result description; (ii) clustering the problem descriptions, action descriptions and result descriptions; (iii) constructing a solution tree data structure based, at least in part, on the clustered descriptions; and (iv) building a machine learning model to predict solutions to reported problems based, at least in part, on the solution tree.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a tree diagram showing a tree based model according to a second embodiment;

FIG. 6 is a block diagram showing clustering of interrelated elements according to the second embodiment;

FIG. 7 is a flowchart showing a machine learning (ML) traversal of a problem-solution path according to the second embodiment;

FIG. 8 is a block diagram showing a machine learning based prediction according to the second embodiment;

FIG. 9 is a block diagram showing an example traversal through a ML enhanced tree according to the second embodiment;

FIG. 10 is a block diagram showing an example tree view according to the second embodiment; and

FIG. 11 is a flowchart diagram showing a second embodiment method.

### DETAILED DESCRIPTION

Some embodiments of the present invention are directed to techniques for building and using machine learning enhanced trees for automated solution determination in a technical support context. Historical technical support records with associated problems, actions and results are received and clustered. A solution determination tree is constructed from the clustered actions, and a machine learning model is trained to predict which action will lead to a solution based on an accumulated data set including a problem and subsequent results from previous actions. Using the solution determination tree and the machine learning model, classes of actions are recommended based on accumulated data for an incoming support request/problem or a result resulting from a executing a previously recommended action.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

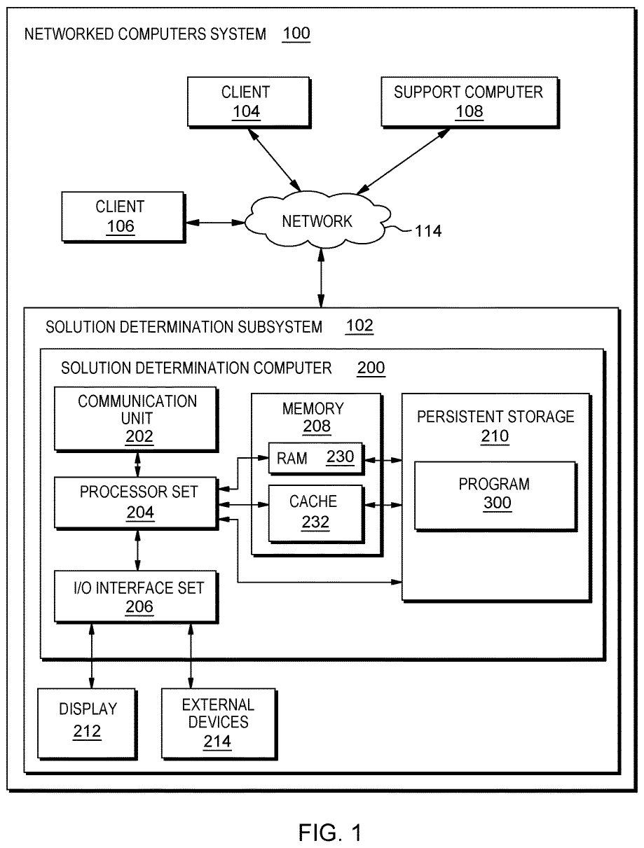

As shown in FIG. 1, networked computers system 100 is an embodiment of a hardware and software environment for use with various embodiments of the present invention. Networked computers system 100 includes: solution determination subsystem 102 (sometimes herein referred to, more simply, as subsystem 102); client subsystems 104 and 106; support computer 108; and communication network 114. Solution determination subsystem 102 includes: solution determination computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with solution determination computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

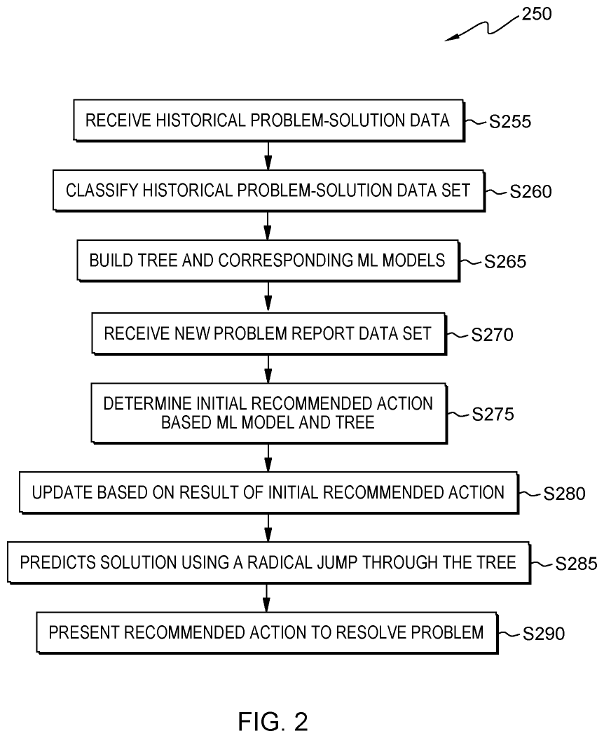

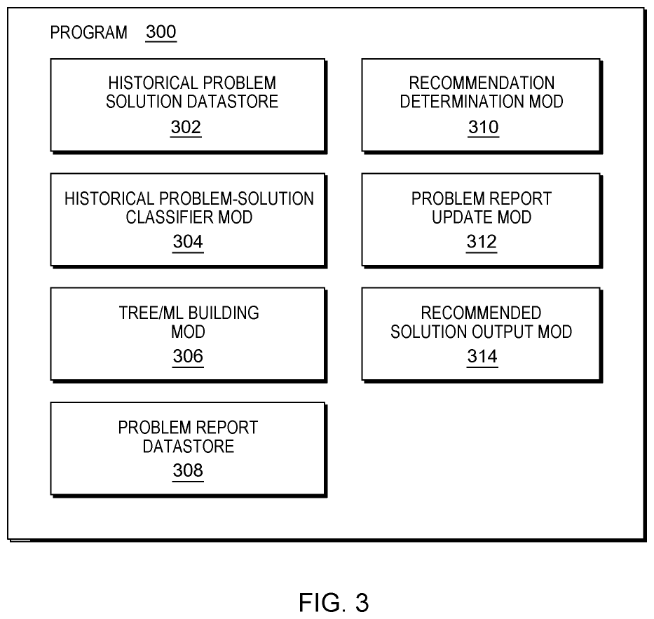

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

Processing begins at operation S255, where historical problem-solution datastore module (“mod”) 302 receives a historical problem-solution data set. In this simplified embodiment, the historical problem-solution data set is a collection of historical technical support records, where each record includes all of the information provided in an initial technical support request, descriptions of each action recommended by technical support services, descriptions of each result stemming from each of the actions (including which action resulted in a successful “close” of the initial technical support request), and information describing the relationship and/or order between the support request, actions and results. In this simplified embodiment, the historical problem-solution data set includes a first support record and a second support record. The first support record includes: (i) a first technical support request (called request 1); (ii) a first support action (shortened to action 1); (iii) a second support action (shortened to action 2); (iv) a third support action (shortened to action 3); (v) a fourth support action (shortened to action 4); (vi) a fifth support action (shortened to action 5); (vii) a first support action result (shortened to result 1); (viii) a second support action result (shortened to result 2); (ix) a third support action result (shortened to result 3); (x) a fourth support action result (shortened to result 4); (xi) a fifth support action result (shortened to result 5); and (xii) a first relationship dataset describing a sequence as follows: request 1, action 1, result 1, action 2, result 2, action 3, result 3, action 4, result 4, action 5, and result 5. The second report record includes the following: (i) a second support request (called request 2); (ii) action 4; (iii) result 4; (iv) action 5; (v) a sixth support action result (called result 6); (vi) a sixth support action (called action 6); (vii) result 5; and (viii) a second relationship dataset describing a sequence as follows: request 2, action 4, result 4, action 5, result 6, action 6, and result 5.

In this simplified embodiment, request 1 includes the following message: “When using ExampleProduct version 2.0 on our servers, the servers keep reporting that they are having memory issues and showing us error code 0013.” Action 1 includes the following message: “Please open the configuration file and change first_value to A.” Result 1 includes the following message: “We opened the config file and changed first_value to A, but the problem is still persisting.” Action 2 includes the following message: “Please try changing second_value to B in the config file.” Result 2 includes the following message: “second_value was already set to B previously. No improvement to the problems on our end.” Action 3 includes the following message: “Try changing third_value to C in the file named configuration.” Result 3 includes the following message: “Changing third_value to C has made things worse! Now we are seeing error code 0013 and error code 0014.” Action 4 includes the following message: “Adjust operating system setting_alpha to X.” Result 4 includes the following message: “setting_alpha is now set to X. We are not seeing error code 0013 anymore but error code 0014 is still persisting, and the out of memory problem is popping up more frequently.” Action 5 includes the following message: “Okay, please change setting_alpha set to Y and modify OS setting_beta to Z.” Result 5 includes the following message: “That fixed everything! All of the problems we have been reporting have been solved as far as we can tell. Thank you.” Request 2 includes the following message: “ExampleProduct version 2.0 is causing memory problems on our server. We keep seeing error codes 0014 and 0015.” Result 6 includes the following message: “Things are a little better, error code 0014 isn't appearing anymore but error code 0015 still pops up, though the problem is occurring less frequently.” Action 6 includes the following message: “Modify the config file parameters such that third_value is now E.”

Processing proceeds to operation S260, where historical problem-solution classifier mod 304 classifies the historical problem-solution data set. In this simplified embodiment, text-based semantic similarity is used to classify the problems, actions and results of the historical problem-solution data set. Words are extracted from each action, result and request, and are used to build each class of requests, actions and results. For example, in this simplified embodiment, request 1 and request 2 respectively include the phrases “memory issues” and “memory problems” and are included in a class called “memory problem” based on semantic similarity between the phrases “memory issues” and “memory problems.” For actions, there are six separate actions that were received as part of the historical problem-solution data set. Actions 1, 2, 3 and 6 respectively include the phrases “configuration file,” “config file,” “file named configuration,” and “config file,” which are determined to have semantic similarity by mod 304, Mod 304 constructs a class of actions named “configuration file” that includes action 1, action 2, action 3 and action 6 as members. Similarly, action 4 and action 5 are determined to be members of a class named “OS setting” because action 4 includes the phrase “operating system setting” and action 5 includes “OS setting,” which are determined to have semantic similarity to each other.

For results, there are six separate results that were received. Result 1 and result 2 are classified into the neutral memory result class, based on their respective inclusion of the phrases “still persisting” and “No improvement.” Result 3 and result 4 are similarly classified into the negative memory result class based on their respective inclusion of the phrases “worse” and “problem . . . more frequently.” Result 5 is the only member classified into the class successful memory solution based on inclusion of the phrase “fixed everything.” Similarly, result 6 is the basis of a class of one called ‘improved but not solved’ on the basis of semantic dissimilarity to other results because of the presence of the phrases “a little better” and “less frequently” with “error . . . still pops up.” In this simplified embodiment, classes are formed from requests, actions and results with relatively low semantic similarity distances. For example, a cluster of actions is formed from actions with semantic similarity distance values below 10% of the average semantic similarity differences of all actions. This 10% of the average is an exemplary value; other values or techniques for clustering may be used in other embodiments of the present invention.

In this simplified embodiment, the class names are selected by a user. In other alternative embodiments, the class name is distilled from the most frequently used words or phrases of class members bearing semantic similarity. It is important to note that the text-based semantic similarity process described above is simplified by virtue of the small sample size presented in the example embodiment. Implementations of the example embodiment would typically involve a significant multitude of elements (requests, actions and results) which would by necessity include many different text-based messages of varying length and wording, prepared by different people. Benefits of text-based semantic similarity classification would become increasingly more beneficial and significant with a greater number of elements from many sources, with many more classes formed from the breadth of requests, actions and results that would be present. In some alternative embodiments, a human user would confirm the labeling of some or all of the classes determined by the classifier. In some alternative embodiments, technical support requests, support actions, and support results may include varied types of information, often in unstructured formats such as screenshots, videos, data file dumps, voice messages, etc. In those alternative embodiments, extra measures must be taken to utilize classification on the provided information. Such measures may include speech-to-text algorithms to extract text from audio files and/or video files, computer-vision text extraction techniques for identifying text in an image (such as a single image or individual frames of a video), etc.

Processing proceeds to operation S265, where tree/machine learning (ML) building mod 306 builds a tree and corresponding ML models. The tree is built by establishing a class of requests as a root node, with branches of the tree comprising actions taken to resolve members of the class of requests, organized based on the classes established at S260. In this simplified embodiment, the memory problems class (with members request 1 and request 2) forms the root node of the tree. Two different classes of actions were created at S260: (i) configuration file; and (ii) OS setting. Configuration file includes four members: (i) action 1; (ii) action 2; (iii) action 3; and (iv) action 6. OS setting includes two members: (i) action 4; and (ii) action 5. From the root node (memory problems), two branches extend: (i) action 1, which begins the ‘configuration file’ class of actions; and (ii) action 4, which begins the ‘OS setting’ class of actions. From action 1, two branches, both also from the ‘configuration file’ class, extend: (i) action 2; and (ii) action 6. From action 2, only one branch extends: action 3. No branches extend from action 3 or action 4 (this makes them terminal nodes, also known as a leaf nodes). From action 4, the first branch on the ‘OS setting’ side of the tree, only one node extends: action 5. Action 5 is also a terminal/leaf node. In some alternative embodiments, there may be more than two branches extending from the root node and/or each branch of the tree. For example, there may be many more than two classes of actions to be taken in response to a class of requests.

In this simplified embodiment, mod 306 builds and/or trains the corresponding machine learning models by training models to predict the class of actions to result in a successful result based on accumulating text from a request through actions and results. This is achieved by training the ML model to recommend the most appropriate class of actions to achieve the desired result (which is a successful resolution to an accumulated text comprising an initial request and results stemming from any subsequent actions from the initial request) through selection of class of actions from the available classes of actions (in this example, the classified actions present in the historical problem-solution data set) and compare against historically traversed paths (with associated actions that are classified in S260) that have led to successful resolutions. For example, for requests that include messages with the phrases “memory problem” and “0013”, the most appropriate class of actions are those in “configuration file.” Requests that include a message with the phrases “memory problem” and “0015,” the most appropriate class of actions are those in the “OS setting.” As actions are presented to the source of the request (and the actions executed), additional information is supplied to the ML model to predict the next class of actions. In some circumstances, where the initial request includes enough information that the ML associates with a particular class of actions, where such actions in the particular class are not typically presented until several other classes of actions are already performed, the ML model may predict the particular class of actions as the most appropriate solution. In some alternative embodiments, predicting a class of actions as most appropriate may further include determining a degree of how applicable each class of actions is to the request. In yet further alternative embodiments, predicting a class of actions as most appropriate may lead to a second stage of analysis and prediction to determine which member of the class is most closely appropriate.

Processing proceeds to operation S270, where problem report data store mod 308 receives a new problem report data set. In this simplified embodiment, the new problem report data set is received from a user-client through client 106 of FIG. 1 and includes the following message: “We've been running ExampleProduct 2.0 on our servers for some time, and recently error code 0013 is popping up alongside some trouble with our memory modules.”

Processing proceeds to operation S275 of FIG. 2, where recommendation determination mod 310 determines an initial recommended action based on the ML model and the tree. In this simplified embodiment, the initial recommended action is based on supplying text from the message included in the new problem report data set (stored in mod 308) to mod 310, which processes the included message through the machine learning model to determine which class of actions is most applicable. In this simplified embodiment, the ML model applies text-based semantic similarity to identify the following phrases as bearing semantic similarity to requests solved through the “configuration file” class of actions: (i) 0013; (ii) trouble; and (iii) memory modules. The ML model determines that actions in the “configuration file” class are most likely to lead to a successful outcome, which is then used by the tree to select action 1 as the initial action.

Processing proceeds to operation S280, where problem report update mod 312 updates recommendation determination mod 310 based on results from execution of the initial recommended action. In this simplified embodiment, between S275 and this step (S280), the initial recommended action determined at S275 is provided to client 106 of the user-client by a technical support person using support computer 108. The user-client executes the recommended action on their end and provides, to support computer 108, a results data set including the following message: “We are seeing insufficient memory problems more frequently, but error code 0013 has been replaced with code 0014 messages.” In this simplified embodiment, this message is included with the previous message received at S270 to create an updated request data set containing the accumulated text of both messages. The accumulated text is processed through text-based semantic similarity for similarity to terms present in the classes of requests, actions and results in the classified historical problem-solution data set. This information is then fed to the ML model for predictions using the updated information.

Processing proceeds to operation S285, where now-updated recommendation determination mod 310 predicts the solution using a radical jump through the tree. In this simplified embodiment, determination mod 310 predicts that actions in the OS setting class are more applicable to provide a solution based on the accumulated text. More particularly, action 5 is the most likely action to lead to a solution based on the accumulated text in the updated request data set bears text-based semantic similarity to those solved by action 5 as per the training of the ML model.

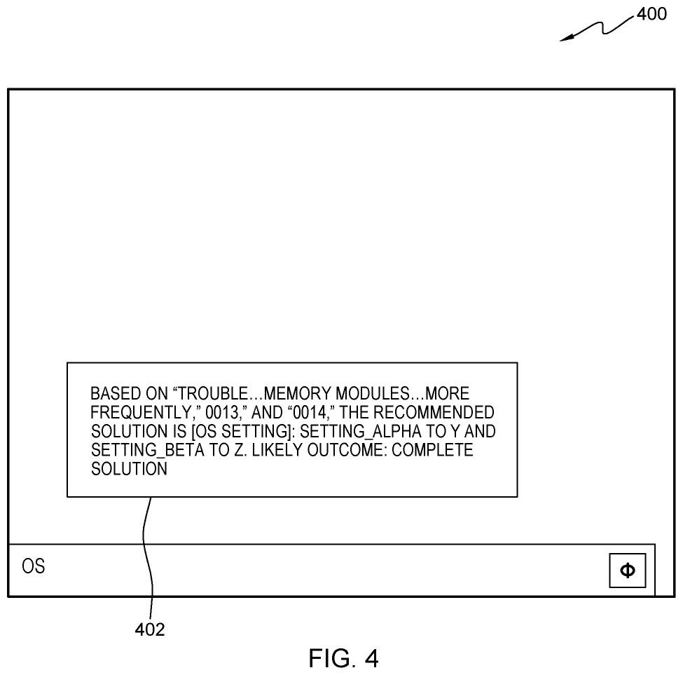

Processing finally proceeds to operation S290, where recommended solution output mod 314 presents the recommended solution to resolve the problem. In this simplified embodiment, action 5 is presented to client 106 from support computer 108 through network 114, shown in the form of a graphical user interface such as in message 402 of screen 400 of FIG. 4. In some alternative embodiments, the solution is automatically communicated to client 106 through network 114. In some alternative embodiments, a recommended solution output includes a predicted result of the predicted recommended action.

### III. Further Comments and/or Embodiments

Some embodiments of the present invention recognize the following facts, potential problems and/or potential areas for improvement with respect to the current state of the art: (i) in customer service, it is important to properly handle customers' requests and questions; (ii) customer support team has to provide a right answer and give a quick solution in time; (iii) for the same problem management record (PMR), there are probably a couple of level 2/level 3 (L2/L3) supports involved in resolving it; (iv) in the current PMR system, L2/L3 supports cannot figure out what other supports have done or are doing, which causes repetition of investigations or tests; (v) huge service history records may be unconstructed data (screenshot images, binary core-dump file, configuration settings, text information in different formats and languages); (vi) there is room to improve supports' working efficiency and accuracy in resolving PMR issues; and (vii) for example, a typical PMR may have over 600 updates for a given case over a period of five months or more, with ten or more L2/L3 support personnel involved in resolving the case.

Some embodiments of the present invention may include one, or more, of the following operations, features, characteristics and/or advantages: (i) a tree-based AI model search & apply mechanism; (ii) a machine learning model is proposed to every branch in the tree for predicting the right path; (iii) mechanism also traverses other paths when the prediction is incorrect; (iv) an innovative combination of tree-based search algorithm with an AI model prediction on each branch of the tree; (v) radical jumps per AI predictions from accumulated results; (vi) predict the correct action or solution for unclear problems; (vii) allowing tree-based traversal in solution space as well as radically jumps between branches of the tree; (viii) if customers find another error when using the recommended solution, the system will jump to another “tree branch” to dig more suitable solutions for the customer; (ix) enables radical jumps per AI predictions from accumulated results; (x) classifying each problem, action, result, and post-action via semantics distance clustering (for example, problems classified into a plurality of problem classes, actions classified into a plurality of action classes; (xi) a tree structure model with classified problems, actions, results, and post-action via semantics distance clustering; (xii) combined with an AI prediction model to provide possible solutions to customer problem requests; (xiii) multi-class AI models on accumulated problem-result text to predict the next action class; (xiv) a method to predict the correct/best action or solution for unclear problems; (xv) the predicted next action class includes all similar actions in the class; (xvi) solution navigation shows in tree-based traversal in solution space as well as radically jumps between branches of the tree; (xvii) finding the best next action/solution; (xviii) an innovative combination of tree-based search algorithm with AI model and machine learning model for prediction on each branch of the tree; (xix) clustering based on word-vector based text semantic similarity; (xx) applying machine learning to the clustering to identify problem/result pairings to action classes (clusters) that lead to desirable results; (xxi) machine learning utilizing decision tree, Naïve Bayes classifiers and support vector machines (SVM); (xxii) features include product word list, phrasal verbs, abbreviation and non-product word list; and (xxiii) providing the predicted correct/best/next action or solution includes providing a plurality of technical guidebooks for one or more actions in the predicted next action class.

Some embodiments of the present invention may include one, or more, of the operations, features, characteristics and/or advantages of the following example: (i) for example, an example problem is a user frequently experiences out of memory errors when using IIB 10.0.0.10; and (ii) two in particular are: (a) JVMJ9VM019E Unrecoverable error: Unable to find and initialize required class java/io/Serializable, and (b) JVMJ9GC070E Failed to startup the Garbage Collector.

An example support action in response to the above example problem might include the following dialogue: “I have reviewed the nmon data and provided the following update to the Customer: I have just tried to reach you at the number provided, but there was no answer. I have looked at the nmon files with an experienced team member and from the data we can see that there are about 11 EG's that is using about 4.5+GB of memory. Could you explain more about the applications that you are running within those EG's? Have your Linux Admins or application team noticed anything that could be taken up by the 4.5+GB's of memory? Also, could you provide a resource statistics document for further reviewing? The resource statistics will show memory allocation into common places such as JVM, global cache, parsers, etc., but I've been informed that resource statistics sometimes doesn't show where the memory is. With that being said, if the memory usage is native memory it will be difficult to track down. We will be checking this document just in case it is not in those common places mentioned previously. In the meantime, I will be discussing my findings with the IIB and Java L3 for them to be aware. Please let me know if you have any questions or run into any issues.”

An example result in response to the above example action might include the following dialogue: “Hi, I have generated all the resource statistics and uploaded the files to ticket. Please let us know if you need any other information. FYI: This issue has been escalated to higher management and they are not at all happy with the progress we made. We will be available over the weekend as well. Please feel free to call us any time if you need any information.”

Some embodiments of the present invention use the following method for predicting the correct action or solution for unclear problems, allowing tree-based traversal in solution space as well as radically jumps between branches of the tree, including the following steps (not necessarily in the following order): (i) classifying each problem, action, result, post-action via semantics distance clustering; (ii) building multi-class AI models based on accumulated problem-result text to predict the next action class; and (iii) providing AI-based predictions as well as tree-based suggestions during solution navigation.

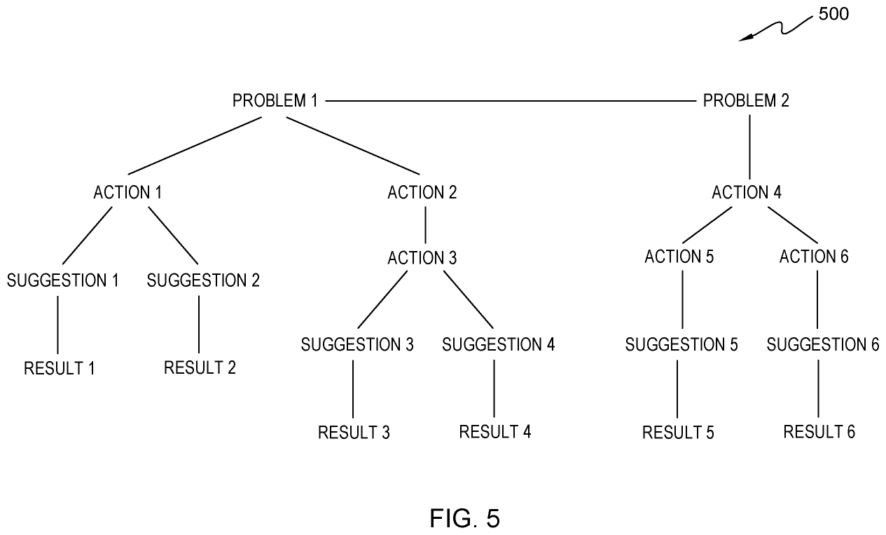

Some embodiments of the present invention leverage the tree based model shown in tree model 500 of FIG. 5, using a tree-based search algorithm with machine learning (ML) based prediction on each branch of the tree.

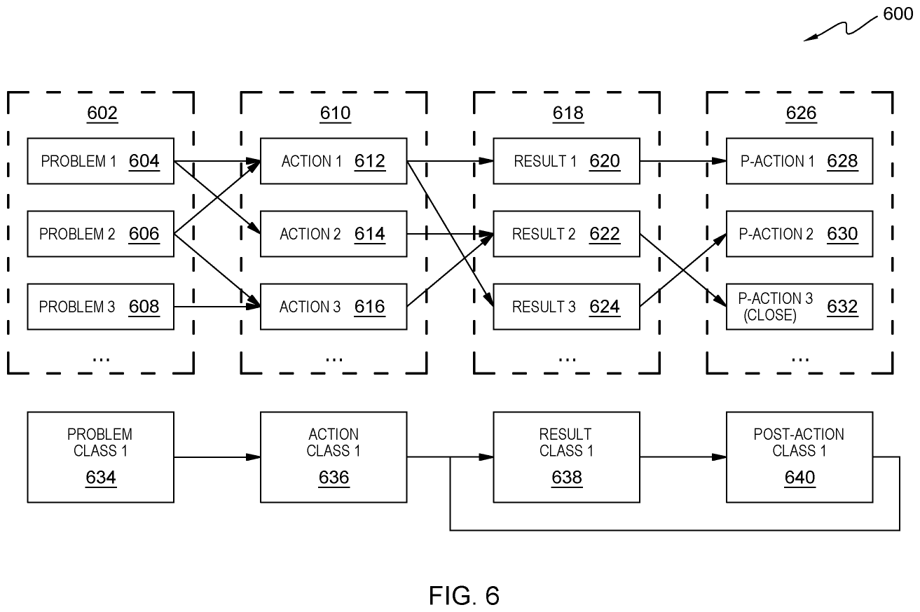

Some embodiments of the present invention cluster elements of a problem-solution data set according to diagram 600 of FIG. 6, which includes the following elements, clusters and classes: (i) problem cluster 602; (ii) problem 1 604; (iii) problem 2 606; (iv) problem 3 608; (v) action cluster 610; (vi) action 1 612; (vii) action 2 614; (viii) action 3 616; (ix) result cluster 618; (x) result 1 620; (xi) result 2 622; (xii) result 3 624; (xiii) post-action cluster 626; (xiv) post-action 1 628; (xv) post-action 2 630; (xvi) post-action 3 632; (xvii) problem class 1 634; (xviii) action class 1 636; (xix) result class 1 638; and (xx) post-action class 1 640.

With respect to FIG. 6, a clustering algorithm clusters similar problems, actions, results and post actions using text-based semantic similarity into distinct classes. The class names may be editable by a human user. For example, problem 1 might be clustered into the label “memory problem”, action 1 clustered into the label “memory configuration”, action 2 clustered into “OS setting”, etc. Each action may also have corresponding technical notes.

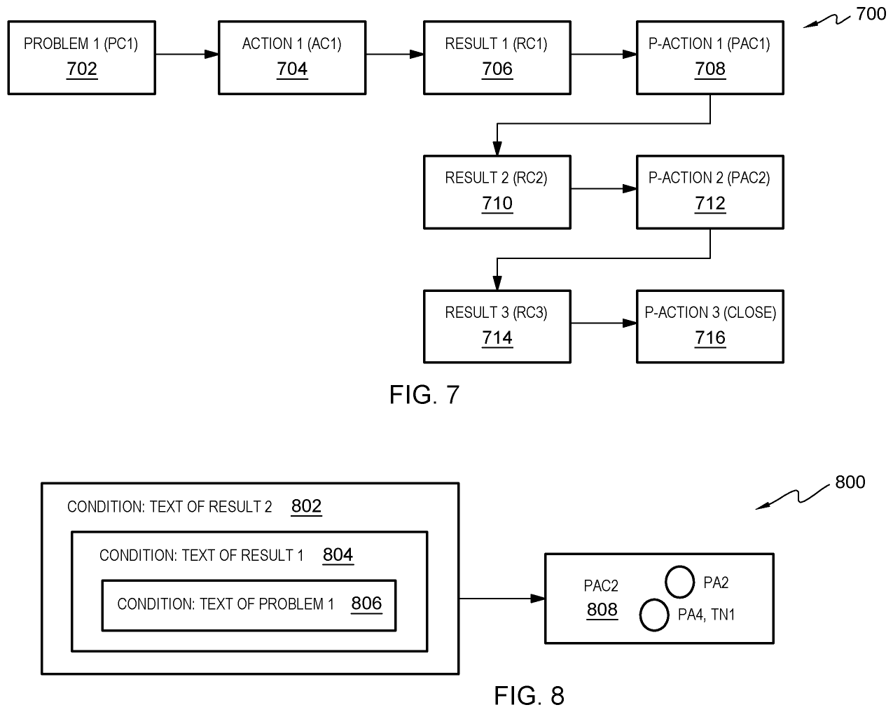

Some embodiments of the present invention include machine learning elements training on traversal paths to a solution through a tree as shown in flow 700 of FIG. 7, which includes the following traversal steps towards resolving problem 1 (PC1) 702: (i) Action 1 (AC1) 704; (ii) Result 1 (RC1) 706; (iii) P-Action (PAC1) 708; (iv) Result 2 (RC2) 710; (v) P-Action 2 (PAC2) 712; (vi) Result 3 (RC3) 714; and (vii) P-Action 3 (close) 716. Regarding flow 700, a machine learning model predicts which next action or post-action (P-Action) class will lead to a successful closure of the original problem using accumulating information, such as results or responses from actions undertaken to resolve the problem. Referring now to diagram 800 of FIG. 8, if the problem is clearly described, the machine learning model can predict the solution to the problem without traversing intermediate steps. For example, if an incoming report includes text with semantic similarity to text of problem 1 806, text of result 1 804 and text of result 2 802, the machine learning model can predict that PAC2 808 will successfully resolve the problem of the incoming report.

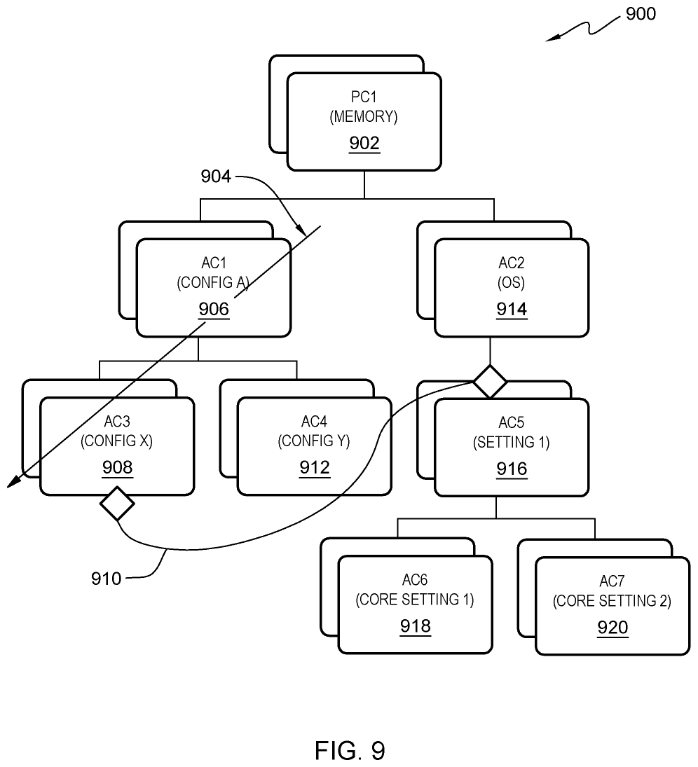

Diagram 900 of FIG. 9 describes an example traversal through a tree of recommended actions using a machine learning model trained to predict the action(s) necessary to resolve a technical support problem/issue. Beginning at the problem, PC1 (memory) 902, the machine learning model proceeds along path 904 through AC1 (config A) 906 and AC3 (config X) 908, accumulating information from the results of 906 and 908. The accumulated results are processed by the machine learning model, which predicts that AC5 (setting 1) 916 is most likely to resolve PC1 (memory 902). The machine learning model then traverses along path 910, bypassing AC4 (config Y) 912 and AC2 (os) 914 altogether. In this example, based on results from performing 916, the machine learning model may predict either AC6 (core setting 1) 918 or AC7 (core setting 2) 920 as the next most likely steps to resolve 902.

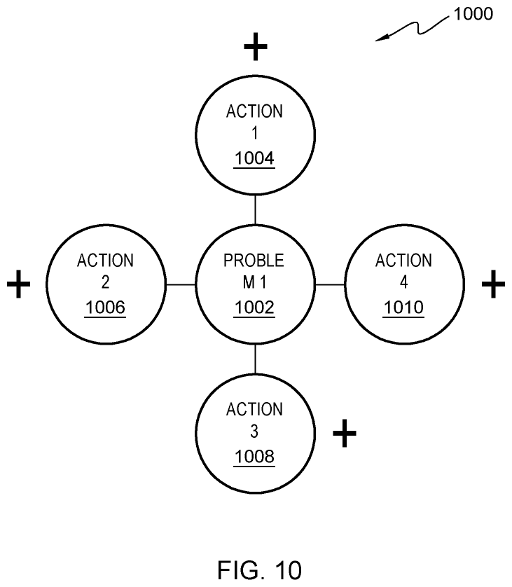

Diagram 1000 of FIG. 10 shows an example problem node in a tree with several corresponding action nodes, including the following elements: (i) Problem 1 1002; (ii) Action 1 1004; (iii) Action 2 1006; (iv) Action 3 1008; and Action 4 1010. Each of the Actions may have subsequent follow-up action nodes corresponding to suggested actions to undertake if the previous action did not resolve Problem 1 1002. Some example actions for the action nodes follows. For Action 1, recommended by the machine learning model: “heap size—You can use the following command to change the JVM heap size(-Xmx) for the broker agent: mqsichangeproperties <BROKER_NAME>-b agent-n jvmMaxHeapSize-o ComlbmJVMManager-v<size in bytes>.” For action 2, also recommended by the machine learning model: “Restart the broker.” For action 3, recommended using the tree structure: “Rerun the flow and send the new generated javacore if any.”

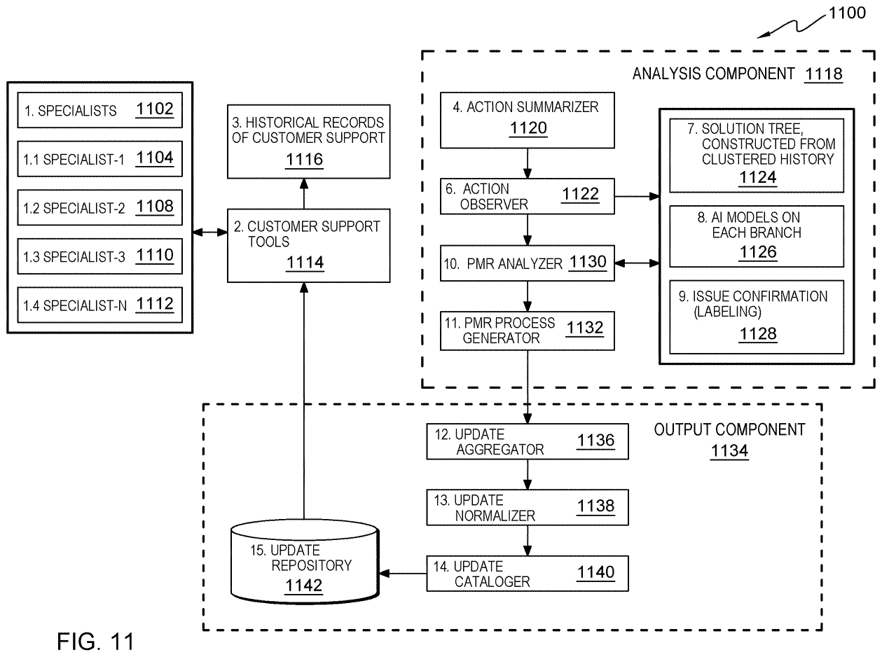

Flowchart diagram 1100 of FIG. 11 shows a method according to an embodiment of the present invention, including the following elements: (i) 1. Specialists 1102; (ii) 1.1. Specialist-1 1104; (iii) 1.2. Specialist-2 1108; (iv) 1.3. Specialist-3 1110; (v) Specialist-N 1112; (vi) 2. Customer Support Tools 1114; (vii) 3. Historical Records of Customer Support 1116; (viii) Analysis component 1118; (ix) 4. Action Summarizer 1120; (x) 6. Action Observer 1122; (xi) 7. Solution Tree constructed from clustered history 1124; (xii) 8. AI Models on each branch, 1126; (xiii) 9. Issue confirmation (labeling) 1128; (xiv) 10. PMR Analyzer 1130; (xv) 11. PMR Process generator 1132; (xvi) Output component 1134; (xvii) 12. Update Aggregator 1136; (xviii) 13. Update Normalizer 1138; (xix) 14. Update Cataloger 1140; and (xx) 15. Update Repository 1142.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

In an Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, and application-specific integrated circuit (ASIC) based devices.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

What is claimed is:

1. A computer-implemented method (CIM) comprising:
receiving a historical technical support records data set including a plurality of technical support records, where a technical support record includes at least one problem description, at least one support action description and at least one result description;
clustering the problem descriptions, action descriptions and result descriptions;
constructing a solution tree data structure based, at least in part, on the clustered descriptions; and
building a machine learning model to predict solutions to reported problems based, at least in part, on the solution tree.

2. The CIM of claim 1, further comprising:
receiving a new technical support problem data set including an initial problem description; and
determining an initial recommended action based, at least in part, on the initial problem description, the machine learning model and the solution tree.

3. The CIM of claim 2, further comprising:
communicating, through a computer network to a computer device, the initial recommended action; and
displaying the initial recommended action on as a graphical user interface on a display connected to the computer device.

4. The CIM of claim 3, further comprising:
responsive to execution of the initial recommended action, receiving a result data set including information indicative of results resulting from executing the initial recommended action; and
determining an updated recommended action based, at least in part, on the result data set, the initial problem description, the machine learning model and the solution tree.

5. The CIM of claim 1, wherein clustering the problem descriptions, action descriptions and result descriptions includes clustering each into a plurality of labeled classes through text-based semantic similarity distance, where clusters are formed from terms with relatively low distance of similarity.

6. The CIM of claim 5, wherein the machine learning model predicting a solution includes selecting a labeled class which includes a cluster of actions, with the selected labeled class determined as the most likely labeled class to lead to a solution.

7. A computer program product (CPP) comprising:
a machine readable storage device; and
computer code stored on the machine readable storage device, with the computer code including instructions for causing a processor(s) set to perform operations including the following:
receiving a historical technical support records data set including a plurality of technical support records, where a technical support record includes at least one problem description, at least one support action description and at least one result description,
clustering the problem descriptions, action descriptions and result descriptions,
constructing a solution tree data structure based, at least in part, on the clustered descriptions, and
building a machine learning model to predict solutions to reported problems based, at least in part, on the solution tree.

8. The CPP of claim 7, wherein the computer code further includes instructions for causing the processor(s) set to perform the following operations:
receiving a new technical support problem data set including an initial problem description; and
determining an initial recommended action based, at least in part, on the initial problem description, the machine learning model and the solution tree.

9. The CPP of claim 8, wherein the computer code further includes instructions for causing the processor(s) set to perform the following operations:
communicating, through a computer network to a computer device, the initial recommended action; and
displaying the initial recommended action on as a graphical user interface on a display connected to the computer device.

10. The CPP of claim 9, wherein the computer code further includes instructions for causing the processor(s) set to perform the following operations:
responsive to execution of the initial recommended action, receiving a result data set including information indicative of results resulting from executing the initial recommended action; and
determining an updated recommended action based, at least in part, on the result data set, the initial problem description, the machine learning model and the solution tree.

11. The CPP of claim 7, wherein clustering the problem descriptions, action descriptions and result descriptions includes clustering each into a plurality of labeled classes through text-based semantic similarity distance, where clusters are formed from terms with relatively low distance of similarity.

12. The CPP of claim 11, wherein the machine learning model predicting a solution includes selecting a labeled class which includes a cluster of actions, with the selected labeled class determined as the most likely labeled class to lead to a solution.

13. A computer system (CS) comprising:
a processor(s) set;
a machine readable storage device; and
computer code stored on the machine readable storage device, with the computer code including instructions for causing the processor(s) set to perform operations including the following:
receiving a historical technical support records data set including a plurality of technical support records, where a technical support record includes at least one problem description, at least one support action description and at least one result description,
clustering the problem descriptions, action descriptions and result descriptions,
constructing a solution tree data structure based, at least in part, on the clustered descriptions, and
building a machine learning model to predict solutions to reported problems based, at least in part, on the solution tree.

14. The CS of claim 13, wherein the computer code further includes instructions for causing the processor(s) set to perform the following operations:
receiving a new technical support problem data set including an initial problem description; and
determining an initial recommended action based, at least in part, on the initial problem description, the machine learning model and the solution tree.

15. The CS of claim 14, wherein the computer code further includes instructions for causing the processor(s) set to perform the following operations:
communicating, through a computer network to a computer device, the initial recommended action; and
displaying the initial recommended action on as a graphical user interface on a display connected to the computer device.

16. The CS of claim 15, wherein the computer code further includes instructions for causing the processor(s) set to perform the following operations:
responsive to execution of the initial recommended action, receiving a result data set including information indicative of results resulting from executing the initial recommended action; and
determining an updated recommended action based, at least in part, on the result data set, the initial problem description, the machine learning model and the solution tree.

17. The CS of claim 13, wherein clustering the problem descriptions, action descriptions and result descriptions includes clustering each into a plurality of labeled classes through text-based semantic similarity distance, where clusters are formed from terms with relatively low distance of similarity.

18. The CS of claim 17, wherein the machine learning model predicting a solution includes selecting a labeled class which includes a cluster of actions, with the selected labeled class determined as the most likely labeled class to lead to a solution.
